(19) United States
(12) Patent Application Publication
(10) Pub. No.: US 2010/0197555 A1
(43) Pub. Date: Aug. 5, 2010

(54) TRIPHENODIOXAZINE DYES

(76) Inventors: Stephen Norman Batchelor, Wirral (GB); Jayne Michelle Bird, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/598,946

(22) PCT Filed: Apr. 21, 2008
(86) PCT No.: PCT/EP2008/054816

§ 371 Date: Mar. 19, 2010

(30) Foreign Application Priority Data
May 18, 2007 (EP) 07108442.0

(51) Int. Cl. C11D 3/40; D06P 3/62

(52) U.S. Cl. 510/301; 510/276

(57) ABSTRACT

The present invention concerns the use of a blue or violet triphenodioxazine direct dye in a laundry composition.

### FIELD OF INVENTION

The present invention concerns the use of dyes in laundry compositions.

### BACKGROUND OF THE INVENTION

Low levels of cotton substantive direct blue or violet dyes may be included in laundry detergent formulations to enhance the whiteness of cellulosic fabrics and to provide an aesthetically pleasing hue to the wash water. Several different types of azo direct dyes have been investigated. Bis-azo dyes based on benzidene chemistry may be used, as described in U.S. Pat. No. 3,748,093 (Colgate), however such dyes are now banned because they are metabolised to carcinogenic amines. Bis-azo dyes such as direct violet 51 or direct violet 9 as described in WO2005/003274 (Unilever) and Cu complex dyes such as direct violet 66 as described in U.S. Pat. No. 3,748,093 (Colgate), may be used. Direct dyes are preferred over other classes of dye due to their strong adsorption to cellulosic fabrics.

Control of the build-up of such dyes is important to avoiding over-blueing.

### SUMMARY OF THE INVENTION

We have found that dyes based on a triphenodioxazine chromophore give more controllable build up.

Triphenodioxazine dyes build up at a slower rate and are less susceptible to bleaching by singlet oxygen photobleaches.

In one aspect the present invention provides a laundry composition comprising between 0.00001 to 0.01 wt % of a blue or violet triphenodioxazine direct dye and 2 to 70 wt % of a surfactant, wherein the triphenodioxazine direct dye is of the form:

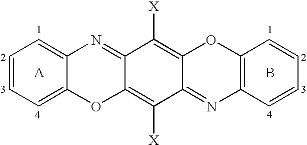

wherein the dye is substituted by 1 to 4 sulphonate groups and X is independently selected from: C1-C6-alkyl, alkyl ester, benzyl, F, Cl, Br and I.

### DETAILED DESCRIPTION OF THE INVENTION

It is preferred that the dye(s) have a peak absorption wavelength of from 550 nm to 650 nm, preferably from 570 nm to 630 nm.

As described above triphenodioxazine direct dyes contain the core structure:

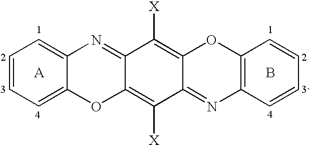

wherein the dye is substituted by 1 to 4 sulphonate groups and X is independently selected from: C1-C6-alkyl, benzyl, F, Cl, Br and I. It is preferred that both X are the same.

The dye is preferably substituted by further organic groups on rings A and B.

It is preferred that the rings A and B are both independently substituted by a group selected from the group consisting of: —NH—Ar, wherein Ar is phenyl or naphthyl; —NH—C1-C6-alkyl, —NH2, —C1-C6-alkyl, —OC1-C6-alkyl, a C3 to C4 alkyl chain linking positions 2 and 3, and a —N(R1)-C2-chain linking position 2 and 3, where R1 is selected from hydrogen, and C1-C6-alkyl.

Preferred substituents for rings A and B are independently selected from the group consisting of: —NH-Ph; —NH-Me, —NH-Et, —NH2, -Me, -Et, —OMe, —OEt, a C3 to C4 alkyl chain linking positions 2 and 3 and a —N(R1)-C2-chain linking position 2 and 3, where R1 is selected from hydrogen, Me and Et. It is these substituents for rings A and B that preferably carry 1 to 3 sulphonate groups. The aromatic group of the —NH-Ph may carry other substituents such as chlorine, alkoxy groups and the like.

The alkyl chain linking positions 2 and 3 is preferably further substituted by a phenyl ring, most preferably such that an indane group is formed. The —N(R1)-C—C— chain linking position 2 and 3 is preferably further substituted by a phenyl ring, most preferably such that an indole group is formed.

Most preferably the triphendioxazine direct dye has the same pattern of substitution about the A and B ring.

In the A and B rings it is preferred that positions 1 and 4, as indicated, are substituted by hydrogen.

Two or three sulphonate groups are preferred and it is preferred that the sulphonates are present as the sodium salt.

Preferred examples of the dye are:

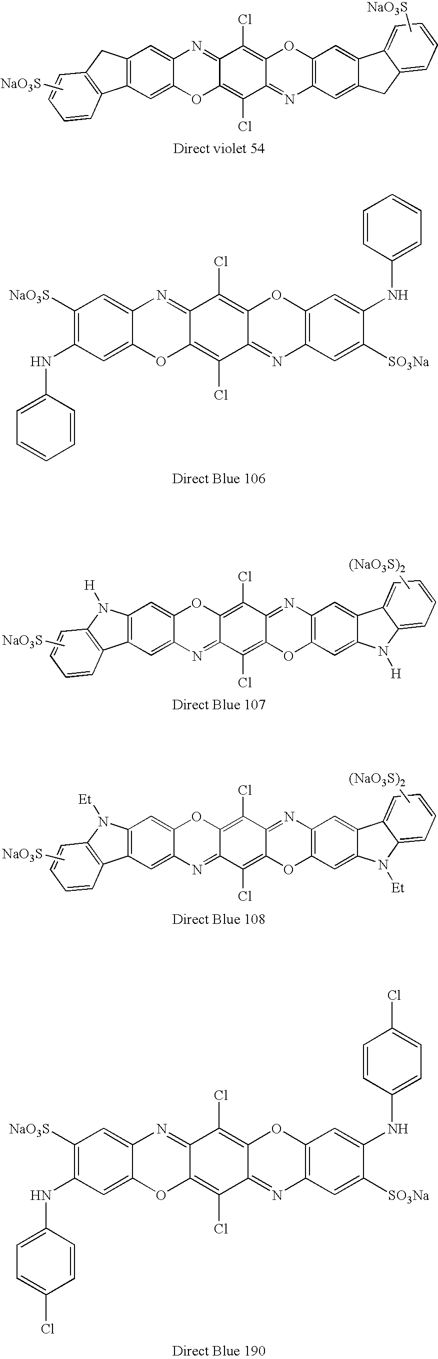

A preferred level of the dye in the laundry composition is 0.00005 to 0.001 wt %.

We have also found that triphenodioxazine based direct dyes show less spotting than other classes of direct dyes.

Other shading dyes may be present, for example, the dyes as disclosed in WO 2006/027086, 2006/045375 and 2006/032327 at similar levels.

### Surfactant

The composition comprises between 2 to 70 wt % of a surfactant, most preferably 10 to 30 wt %. In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981. Preferably the surfactants used are saturated.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆ to C₂₂ alkyl phenol-ethylene oxide condensates, generally 5 to 25 EO, i.e. 5 to 25 units of ethylene oxide per molecule, and the condensation products of aliphatic C₈ to C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈ to C₁₈ alcohols, produced for example from tallow or coconut oil, sodium and potassium alkyl C₉ to C₂₀ benzene sulphonates, particularly sodium linear secondary alkyl C₁₀ to C₁₆ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁ to C₁₅ alkyl benzene sulphonates and sodium C₁₂ to C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆ to C₁₈ primary alcohol sulphate together with a C₁₂ to C₁₅ primary alcohol 3 to 7 EO ethoxylate.

The nonionic detergent is preferably present in amounts greater than 10%, e.g. 25 to 90 wt % of the surfactant system. Anionic surfactants can be present for example in amounts in the range from about 5% to about 40 wt % of the surfactant system.

In another aspect which is also preferred the surfactant may be a cationic such that the formulation is a fabric conditioner.

### Cationic Compound

When the present invention is used as a fabric conditioner it needs to contain a cationic compound.

Most preferred are quaternary ammonium compounds.

It is advantageous if the quaternary ammonium compound is a quaternary ammonium compound having at least one C₁₂ to C₂₂ alkyl chain.

It is preferred if the quaternary ammonium compound has the following formula:

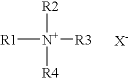

in which R¹ is a C₁₂ to C₂₂ alkyl or alkenyl chain; R², R³ and R⁴ are independently selected from C₁ to C₄ alkyl chains and X⁻ is a compatible anion. A preferred compound of this type is the quaternary ammonium compound cetyl trimethyl quaternary ammonium bromide.

A second class of materials for use with the present invention are the quaternary ammonium of the above structure in which R¹ and R² are independently selected from C₁₂ to C₂₂ alkyl or alkenyl chain; R³ and R⁴ are independently selected from C₁ to C₄ alkyl chains and X⁻ is a compatible anion.

A detergent composition according to claim 1 in which the ratio of (ii) cationic material to (iv) anionic surfactant is at least 2:1.

Other suitable quaternary ammonium compounds are disclosed in EP 0 239 910 (Proctor and Gamble).

It is preferred if the ratio of cationic to nonionic surfactant is from 1:100 to 50:50, more preferably 1:50 to 20:50.

The cationic compound may be present from 1.5 wt % to 50 wt % of the total weight of the composition. Preferably the cationic compound may be present from 2 wt % to 25 wt %, a more preferred composition range is from 5 wt % to 20 wt %.

The softening material is preferably present in an amount of from 2 to 60% by weight of the total composition, more preferably from 2 to 40%, most preferably from 3 to 30% by weight.

The composition optionally comprises a silicone.

### Fluorescent Agent

The composition preferably comprises a fluorescent agent (optical brightener). Fluorescent agents are well known and many such fluorescent agents are available commercially. Usually, these fluorescent agents are supplied and used in the form of their alkali metal salts, for example, the sodium salts. The total amount of the fluorescent agent or agents used in the composition is generally from 0.005 to 2 wt %, more preferably 0.01 to 0.1 wt %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulfophenyl)-2H-napthol[1,2-d]trazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfoslyryl)biphenyl.

### Perfume

Preferably the composition comprises a perfume. The perfume is preferably in the range from 0.001 to 3 wt %, most preferably 0.1 to 1 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

### Singlet Oxygen Photobleaches

Singlet oxygen photo-bleaches (PB) function as follows:

PB+light→PB*

PB*+³O₂→PB+¹O₂

The photo-bleach molecule absorbs light and attains an electronical excited state, PB*. This electronically excited state is quenched by triplet oxygen, ³O₂, in the surroundings to form singlet ¹O₂. Singlet oxygen is a highly reactive bleach.

Suitable singlet oxygen photo-bleaches may be selected from, water soluble phthalocyanine compounds, particularly metallated phthalocyanine compounds where the metal is Zn or Al-Z1 where Z1 is a halide, sulphate, nitrate, carboxylate, alkanolate or hydroxyl ion. Preferably the phthalocyanin has 1-4 SO₃X groups covalently bonded to it where X is an alkali metal or ammonium ion. Such compounds are described in WO2005/014769 (Ciba).

Xanthene type dyes are preferred, particularly based on the structure:

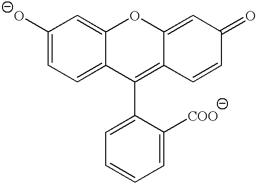

where the dye may be substituted by halogens and other elements/groups. Particularly preferred examples are Food Red 14 (Acid Red 51), Rose Bengal, Phloxin B and Eosin Y.

Quantum yields for photosensitized formation of singlet oxygen may be found in J. Phys. Chem. Ref. Data 1993, vol 22, not pp 113-262. It is preferred if the quantum yield for singlet oxygen formation measured in an organic solvent or D2O is greater than 0.05, more preferably greater than 0.1.

Other singlet oxygen producing compounds include chlorophyll, coumarin, porphyrins, myoglobin, riboflavin, bilirubin, and methylene blue.

The laundry composition preferably comprises from 0.00005 to 0.1 wt % of a singlet oxygen photo-bleach, more preferably 0.0002 to 0.01 wt %. This is to provide the preferred range of 1 ppb to 4 ppm of the singlet oxygen photo-bleach the in wash.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

Except in the operating and comparative examples, or where otherwise explicitly indicated, all numbers in this description indicating amounts of material ought to be understood as modified by the word “about”.

### EXAMPLES

All experiments were conducted at room temperature, ca 20° C.

### Example 1

Non-mercerised bleached white cotton sheeting, white viscose sheeting and white knitted nylon elastane were agitated together in 2 g/L of a detergent formulation (containing 18% NaLAS surfactant, 73% salts (silicate, sodium tri-poly-phosphate, sulphate, carbonate), 3% minors including fluorescer and enzymes, remainder impurities) for 30 minutes with a liquor to cloth ration of 30:1. The wash liquor contained a direct dye, such that initial optical density of the wash solution at the maximum optical absorption of the dye in the visible (400-750 nm) was 1.0 with a 5 cm path length.

Before the washing the reflectance spectra of the cloths were read using a reflectomer (UV-light excluded). After the 1^{st} wash the cloths were dried and the reflectance spectra were re-read. The cloths were than washed under identical conditions 4 more times and then reflectance spectrum re-recorded.

The reflectance data was converted to remission function K/S using the equation:—

K/S=(1−R)²/(2R)

The remission function is proportional to the loading of the dye on the cloth in mol/kg when the background reflectance of the cloths is corrected for, from reading on cloths washed without dye.

DCI, The increase in dye loading between the 1^{st} and 5^{th} wash was calculated according to the equation

DCI=K/S(5^{th} wash)/K/S(1^{st} wash)

Where the K/S value is background corrected and is at the lambda max of the dye on the cloth.

The results are shown in the tables below

| | | DCI | DCI |
|---|---|---|---|
| Dye | Chromophore type | cotton | viscose |
| Direct violet 9 | Bis-azo | 4.5 | 3.9 |
| Direct blue 71 | Tris-azo | 3.5 | 3.4 |
| Direct violet 66 | Cu-complex | 3.5 | 3.7 |
| Direct blue 106 | Triphenodioxazine | 2.9 | 3.2 |
| Sirius Royal Blue- | Triphenodioxazine | 3.2 | 3.1 |
| S (ex Dystar) | | | |

The triphenodioxazine dyes show a slower build up than the other classes of dye.

### Example 2

Two pieces of Korean cotton sheeting weighing a total of 3.8 g were washed together in 100 ml of demin. water containing 4 g/L of ECE reference detergent (type A) for 30 minutes then thoroughly rinsed. The wash solution contained:

a) nothing else (control)
b) acid red 51+direct blue 106
c) acid red 51+direct violet 66
d) acid red 51+direct violet 9
e) acid red 51+direct blue 71
f) acid red 51+Sirius Royal Blue-S

The acid red 51 was added to give 1.7 ppm in solution and the direct dyes to give a maximum optical absorption of the dye in the visible (400-750 nm) of 0.5 with a 5 cm path length.

Acid red 51 is an active singlet oxygen photobleach.

Following the washes 1 piece of cloth was dried in the dark and 1 piece dried in a weatherometer for 42 minutes (0.35 W/m² at 340 nm, indoor glass filter). The reflectance of the clothes were then measured with a reflectometer and the dye that has been photobleached calculated. The K/S of the dye at its lambda max was calculated and values in the dark and light exposed clothes compared. (All values corrected for the background). The lambda max of the direct dyes are well removed from the absorbance of acid red 51. The results are given in the table below

| Dye | % photobleached |
|---|---|
| Direct violet 9 | 22 |
| Direct violet 66 | 25 |
| Direct blue 71 | 11 |
| Direct blue 106 | 6 |
| Sirius royal blue-S | 0 |

The triphenodioxazine dyes are much less susceptible to photobleaching by acid red 51.

1. A laundry composition comprising between 0.00001 to 0.01 wt % of a blue or violet triphenodioxazine direct dye and 2 to 70 wt % of a surfactant, wherein the triphenodioxazine direct dye is of the form: 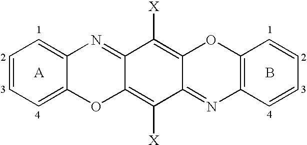
wherein the dye is substituted by 1 to 4 sulphonate groups and X is independently selected from: C1-C6-alkyl, alkyl ester, benzyl, F, Cl, Br and I.

2. A laundry composition according to claim 1, wherein X═Cl, C1-C6-alkyl, or benzyl, and rings A and B are both independently substituted by a group selected from the group consisting of: —NH—Ar, wherein Ar is phenyl or naphthyl; —NH—C1-C6-alkyl, —NH2, —C1-C6-alkyl, —OC1-C6-alkyl, a C3 to C4 alkyl chain linking positions 2 and 3, and a —N(R1)-C2-chain linking position 2 and 3, where R1 is selected from hydrogen, and C1-C6-alkyl.

3. A laundry composition according to claim 1, wherein X═Cl, and rings A and B are both independently substituted by a group selected from the group consisting of: —NH-Ph; —NH-Me, —NH-Et, —NH2, -Me, -Et, —OMe, —OEt, a C3 to C4 alkyl chain linking positions 2 and 3, and a —N(R1)-C2-chain linking position 2 and 3, where R1 is selected from hydrogen, Me and Et.

4. A laundry composition according to claim 3, wherein the alkyl chain linking positions 2 and 3 or the —N(R1)-C2-chain linking position 2 and 3 is further substituted by a phenyl ring.

5. A laundry composition according to claim 4, wherein the alkyl chain linking positions 2 and 3 is further substituted by a phenyl ring forms an indane moiety or indole moiety.

6. A laundry composition according to claim 1, wherein triphenodioxazine direct dye has the same pattern of substitution about the A and B ring.

7. A laundry composition according to claim 1, wherein positions 1 and 4 of the A and B ring are substituted by hydrogen.

8. A laundry composition according to claim 2, wherein the triphenodioxazine direct dye is selected from:

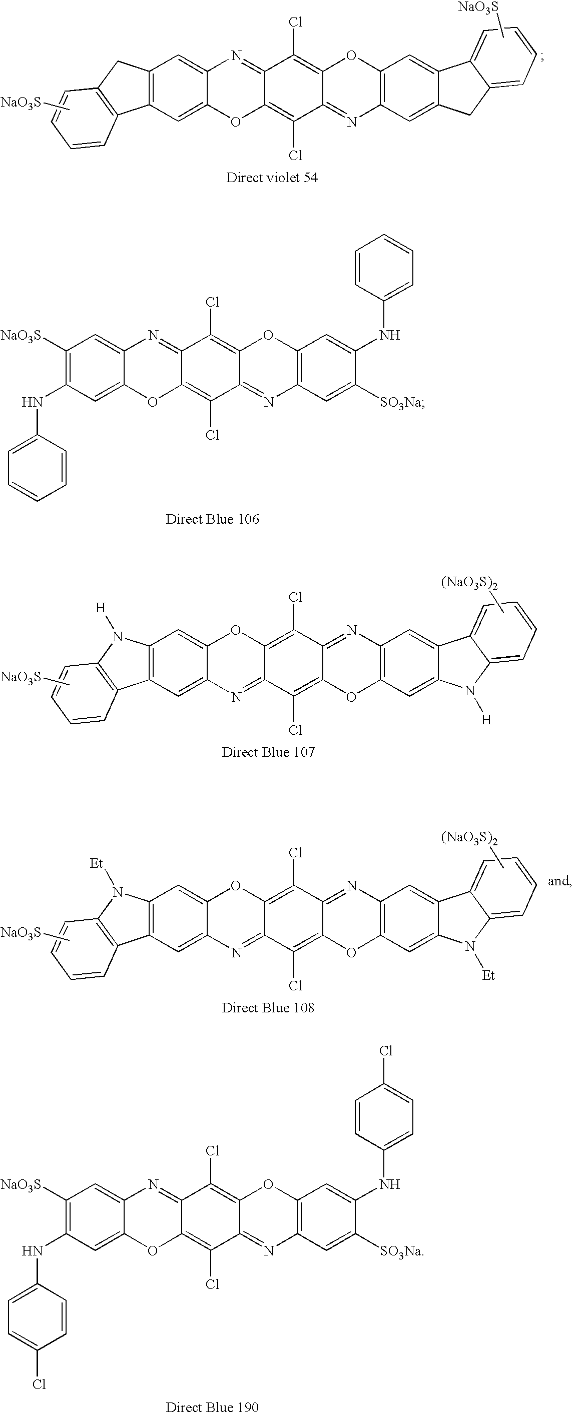

9. A laundry composition according to claim 1, wherein the laundry composition comprises from 0.00005 to 0.1 wt % of a singlet oxygen photo-bleach.

10. A domestic method of treating a textile, the method comprising the steps of:
(i) treating a textile with an aqueous solution of the dye according to claim 1, the aqueous solution comprising from 1 ppb to 1 ppm of the dye, and, from 0.2 g/L to 3 g/L of a surfactant; and,
(ii) rinsing and drying the textile.

11. A method according to claim 10, wherein 0.2 g/L to 2.5 g/L of a surfactant is present.

12. A method according to claim 10, wherein the dye is present from 1 ppb to 20 ppb of the dye.

13. A method according to claim 10, wherein a singlet oxygen photo-bleach is present in the range from 1 ppb to 4 ppm.
